(19) United States
(12) Patent Application Publication
(10) Pub. No.: US 2016/0091139 A1
(43) Pub. Date: Mar. 31, 2016

(54) SELFIE DEVICE HOLDER

(71) Applicant: The Cellfie, LLC, Weston, FL (US)

(72) Inventors: Scott Levine, Weston, FL (US); Christopher Ure, Weston, FL (US); Mark Mazloff, Weston, FL (US)

(21) Appl. No.: 14/498,210

(22) Filed: Sep. 26, 2014

(51) Int. Cl. F16M 13/04; G03B 17/38

(52) U.S. Cl. CPC F16M 13/04; G03B 17/38

(57) ABSTRACT

A portable electronic device holder allows for quick mounting and telescoping of a cell phone or smart phone to enable a convenient recording of a selfie image. The device holder has a clamp section having a fixed thirty degree orientation relative to a telescoping handle section. The fixed angle reduces mounting complexity of the device as well as enhancing portability of the device holder. The clamp section also has a hinge that reduces the size of the clamp section when not in use, thereby further enhancing the portability of the device holder. The telescoping handle has an elliptical shape and or a groove that increases strength and durability, as well as enabling a secure holding of the device holder in operation while facilitating a natural horizontal orientation of the camera for recording of the selfie.

### BACKGROUND

The present disclosure generally relates to a telescoping mounting system for a portable electronic device able to record selfie images.

Modern portable electronic devices such as cell phones, smart phones, tablets, phablets, and handheld gaming systems have enabled the popularization of the selfie photograph or selfie video image recording. Such devices have a camera and a display arranged on a common surface. This arrangement allows the user to spontaneously hold the device at arm's length, point the device's camera towards himself or herself as well as any other persons or subject matter in the viewing range of the camera, and then view the framing of the image prior to recording a photograph or while recording a video image including the user. Ergo, the “selfie” image.

Holding the portable electronic device at arm's length may limit viewing range of the camera. If a user wants to increase the viewing range of the camera, the camera may need to be located a length further from the user than the length allowed by the arm of the user.

Monopole systems have been designed for cameras which attach to a threaded hole in the base of the camera using a corresponding threaded screw attached to the monopole. Such monopoles typically include a bulky swivel joint allowing almost infinite flexibility in the location of the camera on the monopole by providing three hundred and sixty degree rotation in one axis and almost a full three hundred and sixty degree tilting in another axis. However, for selfies, cell phones and similar devices are small and are not manufactured with the threaded hole included in the base of most cameras. Furthermore, while a bulky swivel joint with infinite flexibility may have advantages in flexible mounting of a camera for wide variety of photographic applications, it often requires a significant amount of time and awkward adjustments to set up, therefor detracting from spontaneity of the selfie application.

Clamps may be attached to monopoles to clamp a cell phone to a monopole to resolve the issue that cellphones do not have the threaded hole included with most cameras for mounting to a monopod or tripod. However, the resulting clamping system may produce an awkward infinitely flexible cellphone mounting systems which adds bulk and is thus difficult to carry and use in situations where spontaneous selfies are desired.

### SUMMARY

In one example non-limiting of the description, a portable electronic device holder includes a handle and a clamp. The clamp includes a hinge that reduces the size of the clamp when not in a portable mode and not being used for clamping the portable electronic device.

In another non-limiting example of the description a portable electronic device holder includes a handle and a clamp. The clamp has a clamping surface with a fixed angle relative to the handle for allowing the user holding the handle to view and record a selfie-photograph including the user while holding the portable electronic device holder.

In another non-limiting example of the description a portable electronic device holder includes a handle and a clamp. The handle is telescoping and has an elliptical shape that adds strength and durability while extended and a comfortable and more secure and responsive holding while a user records a selfie image. In another example the telescoping handle may include a groove in either a circular or elliptical handle to add strength during telescoping and deter rotation of the portable electronic device.

### BRIEF DESCRIPTION OF THE SEVERAL VIEWS OF THE DRAWINGS

The accompanying figures wherein reference numerals refer to identical or functionally similar elements throughout the separate views, and which together with the detailed description below are incorporated in and form part of the specification, serve to further illustrate various examples and to explain various principles and advantages all in accordance with the present description, in which:

FIG. 1 shows a side view of a portable electronic device holder in an active position clamping a portable electronic device;

FIG. 2 shows a side view of the portable electronic device holder in an idle position;

FIG. 3 shows a perspective view of the portable electronic device holder in the active position;

FIG. 4 shows a perspective view of the portable electronic device holder in the idle position;

FIG. 5 shows a side view of a user recording a selfie image while holding the portable electronic device holder clamping a portable electronic device;

FIG. 6 shows an example of a cross-section of an elliptically shaped telescoping element of the telescoping handle;

FIG. 7 shows an example of a cross-section of a telescoping element of the telescoping handle having a groove

FIG. 8 shows a top view of a portable electronic device holder with the telescoping element of FIG. 7 in a retracted position; and

FIG. 9 shows a perspective view of the portable electronic device holder of FIG. 8 with the telescoping element of FIG. 7 in an extended position.

### DETAILED DESCRIPTION

As required, detailed examples are disclosed herein; however, it is to be understood that the materials disclosed are merely examples and that the apparatuses, systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present disclosure is presented for purposes of illustration and description, but is not intended to be exhaustive or limited in the form disclosed. Many modifications and variations will be apparent without departing from the scope of the description. The examples are chosen and described in order to best explain the principles of the description and the practical application, and to enable others to understand the description for various examples with various modifications as are suited to the particular use contemplated.

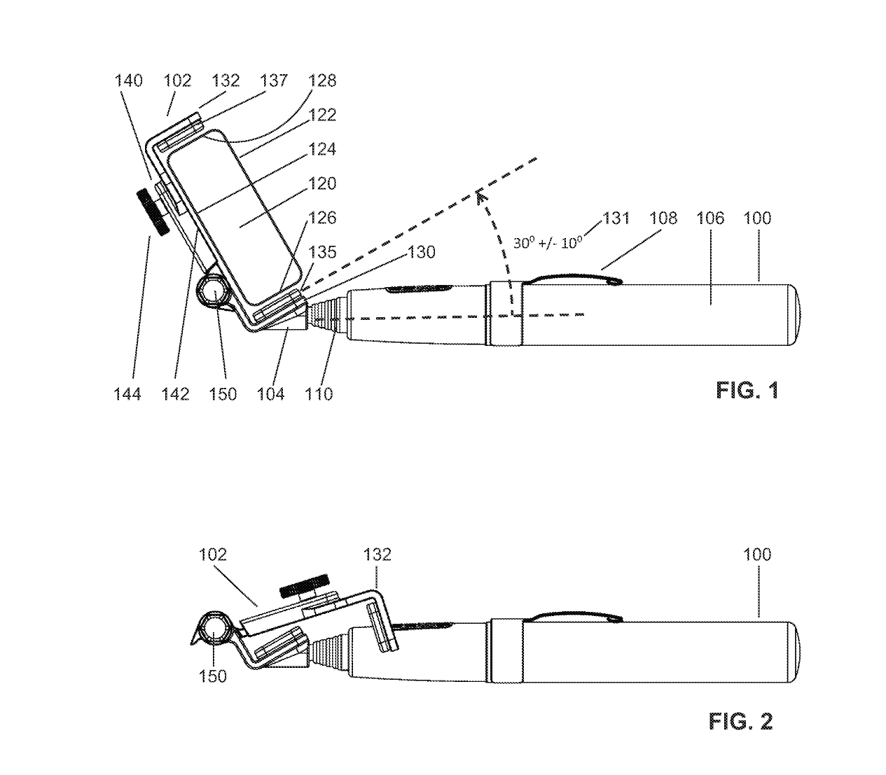

FIG. 1 shows a side view of a portable electronic device holder in an active position clamping a portable electronic device. The device holder has a handle section 100 and detachable a clamp section 102. The handle is coupled to the clamp with thread screw mechanism 104, such as a course helical thread to simplify and minimize rotations when attaching or removing the clamp section from the handle section. Screw mechanism 104 may also allow for interchangeable end effects to be installed at the end of the handle to accommodate future devices. In other examples, different approaches to attaching an end effect, such as clamp section 102, to the handle are anticipated while remaining within the scope of this description.

The handle has a gripping section 106 to facilitate the holding of the handle in a hand of a user. The handle may be comprised of a two piece decoration design that allows for a changing of the aesthetic appearance of the handle as well as modifications of colors, logos and branding. An optional clip 108 allows the device holder to be more easily carried by the user. A telescoping section 110 allows the distance between the gripping section 106 and clamp section 102 to be increased, thereby extending the distance between the user and the camera for enhanced selfie recordings. Telescoping section 110 may be comprised of a larger number of thicker shorter members, thereby allowing for a smaller closed sized while maintaining the overall desired length when extended and increases rigidity

The handle gripping section 106 and telescoping section 110 may have an elliptically shaped circumference. The ellipse has a long axis and a short axis, with the longer axes of the ellipse orientated perpendicular to the plane of the first clamping surface, and in typical operation the user may orientate the device holder in the vertical direction relative to the ground. This orientation of the ellipse section not only facilitates the telescoping of the clamping section but also adds strength and durability to the telescoping section in supporting the weight of the clamp and the portable electronic device. The extra strength provided for by the elliptical configuration may allow for a reduction in materials used the handle and thus a reduction in weight and cost of the device holder, thereby enhancing portability of the device holder while providing a cost reduction. Furthermore, the elliptical shape deters rotation of the clamp and portable electronic device system relative to the handle when suspended at the end of the telescoping system and allows the user both a more comfortable and secure grip on the handle and a more comfortable and intuitive control over the angle over the horizontal orientation of the portable electronic device while recording the selfie because the camera is orientated horizontally when the long axis of the ellipse of the handle is orientated vertically. Thus the user may use the feel of the elliptical handle and its orientation relative to the ground to assist in establishing a desired orientation of the camera.

FIG. 6 shows an example of a cross-section of an elliptically shaped telescoping element of the telescoping handle. Elliptically shaped circumference 600 of the telescoping element has a longer axis 602 which may be orientated vertically and perpendicular to the plane of the first clamping surface during operation and a shorter axis 604 which may be orientated horizontally during operation.

FIG. 7 shows an example of a cross-section of a telescoping element of the telescoping handle having a groove. The circumference 700 is shown as a circle, but in other examples, other circumference shapes such an ellipse or oval may be used while remaining within the scope of this description. Included in the circumference is a groove 702 which not only facilitates the telescoping of the clamping section but also adds strength and durability to the telescoping section in supporting the weight of the clamp and the portable electronic device. The extra strength provided for by the groove configuration may allow for a reduction in materials used in the handle and thus a reduction in weight and cost of the device holder, thereby enhancing portability of the device holder while providing a cost reduction. Furthermore, the groove shape deters rotation of the clamp and portable electronic device system relative to the handle when suspended at the end of the telescoping system.

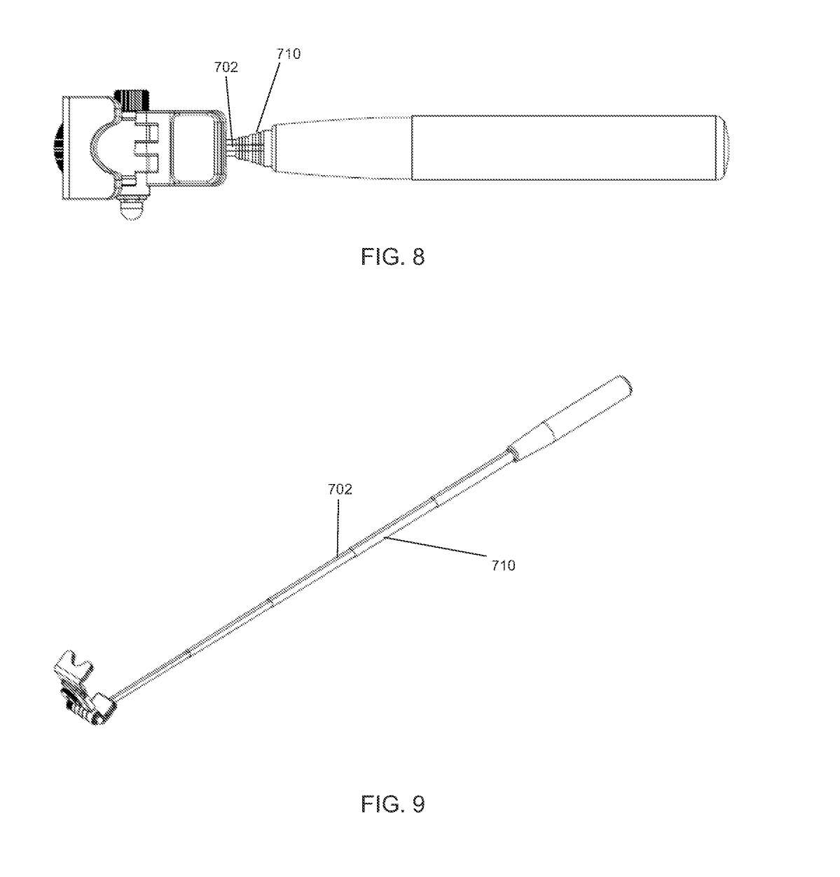

FIG. 8 shows a portable electronic device holder with the telescoping element 710 of FIG. 7 in a retracted position and FIG. 9 shows the portable electronic device holder with the telescoping element 710 of FIG. 7 in an extended position.

The portable electronic device 120 is shown clamped by clamp section 102. The portable electronic device has a front surface 122 which may include a camera and a display such as those incorporated into many cell phones, smart phones, tablets, phablets and other such devices of various dimensions. The portable electronic device also has a generally planar rear surface 124 which is may be referred to as the back side of a cell phone or smart phone. Rear surface 124 may also include a camera and a flash for illuminating recording of images. The portable electronic device also has sided surfaces 126 and 128 which may be engaged by clamping surfaces of clamp section 102.

The clamp section 102 includes a first clamping surface 130 having a fixed angle 131 relative to the handle 100 and coupled or attached to the handle. A fixed angle of substantially 30 degrees has been experimentally found to provide for increased durability and simplicity of operations while holding the device holder for recording selfie images. The fixed angle allows for elimination of the swivel joint associated with camera monopods. Elimination of the swivel joint reduces the bulk associated with a monopod and simplifies the complexity of orientating the portable electronic device for quickly mounting the portable electronic device to the holder, establishing camera orientation, and recoding a selfie. It also allows for secure mounting of the portable electronic device in the clamp section under most typical orientation positions involved in recording selfie images. In practice, the fixed angle of substantially thirty degrees corresponds to a thirty degree angle plus or minus two degrees. However similar benefits may be found at fixed angles ranging from twenty degrees to forty degrees. Thus, the fixed angle provides for the quick set up of the portable electronic device holder and the portable electronic device for recording. The rapid setup provides for faster and more convenient recording of selfie images. Furthermore, the fixed angle eliminates the swivel joint associated with monopods, thereby simplifying the setup of the portable electronic device for recording selfie while conveniently reducing the cost, bulk and weight of the handle.

In FIG. 1, a second clamping surface 132 is located parallel to the first clamping surface 130. The first clamping surface 130 and the second clamping surface 132 are adapted to clamp side surfaces 126 and 128 of portable electronic device 120. The portable electronic device has a front surface 122 having a front mounted display and a front surface mounted camera whereby a user holding the handle may record a selfie image including the user with the portable electronic device 120.

The first clamping surface 130 and the second clamping surface 132 include a corresponding first friction pad 135 and second friction pad 137. The friction pads substantially cover the entire area of the clamping surfaces and may provide a small reveal of the clamping surfaces at the perimeter of the friction pad. The friction pads allow for improved clamping of sides 126 and 128 of portable electronic device 120 and substantially cover the clamping surfaces in such a way that the portable electronic device securely engages the friction pads 135 and 137 while providing minimal if any direct contact between the sides of the portable electronic device and the clamping surfaces 130 and 132. In one example, the friction pads may comprise an elastomeric material. The elastomeric material may have a thickness and composition that allows for the creation of custom contours for varying geometries of side surfaces 126 and 128. For example one portable electronic device may present wide flat side surfaces 126 and 128 as shown in FIG. 1, while another portable electronic device may present very thin surfaces having a sharp radius. The elastomeric material may at least partially conform to the shape of the side surfaces and accommodate the secure clamping of both side surfaces. While friction surfaces comprising an elastomeric material are described in this example, other friction surfaces facilitating the secure clamping of the electronic device are considered to be within the scope of this description. In still other examples, the friction pads may be eliminated while remaining within the scope of this description.

The clamp section 102 further includes a sliding arm assembly 140 having a sliding range, the sliding arm assembly is coupled between the first clamping surface 130 and the second clamping surface 132 for adjusting a distance between the first clamping surface and the second clamping surface to provide for clamping of a plurality of portable electronic devices 120 of various dimensions. The sliding arm presents a planar surface 142 for receiving the rear planar surface 124 of the portable electronic device 120 while clamped. The planar surface 142 of the clamp mates with corresponding planar surface 124 of the portable electronic device for providing an increased stability and affixing of the portable electronic device to the holder while clamped. The sliding arm assembly 140 further includes a first locking lug 144 for fixing a distance between the first clamping surface and the second clamping surface. When the first locking lug 144 is rotated clockwise and tightened, the sliding arm assembly is locked in its current position. When the first locking lug 144 is rotated counterclockwise and loosened, the sliding arm assembly is unlocked and able to slide through it sliding range to clamp the portable electronic device. The geometry of the sliding arm assembly 140 may include ribs, steps or stiffeners to create a more rigid clamp when adjusted and secured by first locking lug 144.

In operation the locking lug 144 is unlocked and the distance between the first and second clamping surfaces is increased to facilitate locating the planar rear surface of the portable electronic device to be received by corresponding planar surface 142. Then, the distance between the first and second clamping surfaces is decreased providing a tension fit clamp of the portable electronic device between the clamping surfaces. Finally, the first locking lug 144 is locked and the portable electronic device is securely mounted in the holding device for the recording of photographs. This procedure may be performed in reverse to remove the portable electronic device from the device holder. In another example, the device may be removed from or reinstalled into the claim without loosening the first locking lug by overcoming the tension fit. This allows the sliding arm assembly to be adjusted a single time for clamping a specific portable electronic device while allowing for its repeated removal and reinstallation. Further, the clamp may pivot between active and idle positions without requiring unlocking of the first locking lug.

In other examples, the sliding arm assembly may include a spring, ratchet system or other system known to those familiar with the art to enabling clamping of the portable electronic device by the first and second clamping surfaces 130, 132 while presenting a planar surface 136 for receiving rear surface 124 of the portable electronic device 120. As such sliding assemblies and systems are considered to be within the scope of this description. Further, in alternate embodiments the sliding arm assembly 140 may be eliminated and another system utilized to facilitate clamping of portable electronic device 120 between clamping surfaces 130 and 132 while being received by planar surface 142.

The clamp 102 also includes a hinge 150 coupled to the first clamping surface 130 and the second clamping surface 132 through the sliding arm assembly 140 and for rotating the second clamping surface 132 and the sliding arm assembly 140 between an active position for clamping a portable electronic device within the first clamping surface and the second clamping surface, and an idle position.

FIG. 2 shows a side view of the portable electronic device holder in an idle position. In the idle position the size of the clamp when not clamping the portable electronic device is reduced. In the idle position the portable electronic device 120 has been removed from the clamp 102. Then the second clamping surface 132 and the sliding arm assembly 140 are rotated from the active position to the idle position. Hinge 150 allows the sliding arm assembly 140 and the second clamping surface 132 to rotate proximate to the handle 100. The folding axis of rotation provided by hinge 150 is offset from the main axis of telescopic member to minimize the size of the clamp section when folding and allowing for further intimate interfacing of the upper portion of the clamp section with the handle. Second clamping surface being located proximate to the handle may be defined as the second clamping surface contacting the handle, engaging the handle or being located close to the handle or in a close proximity with the handle such that the size of the clamp is reduced thereby allowing for enhanced portability when a portable electronic device is not being clamped. In one example, the second clamping surface 132 may be rectangular in shape with a flat edge of the rectangle resting in proximity with the handle in the idle position. In another example the second clamping surface may have a shape adapted to further engage the handle and further reduce the size of the clamp when in the idle position.

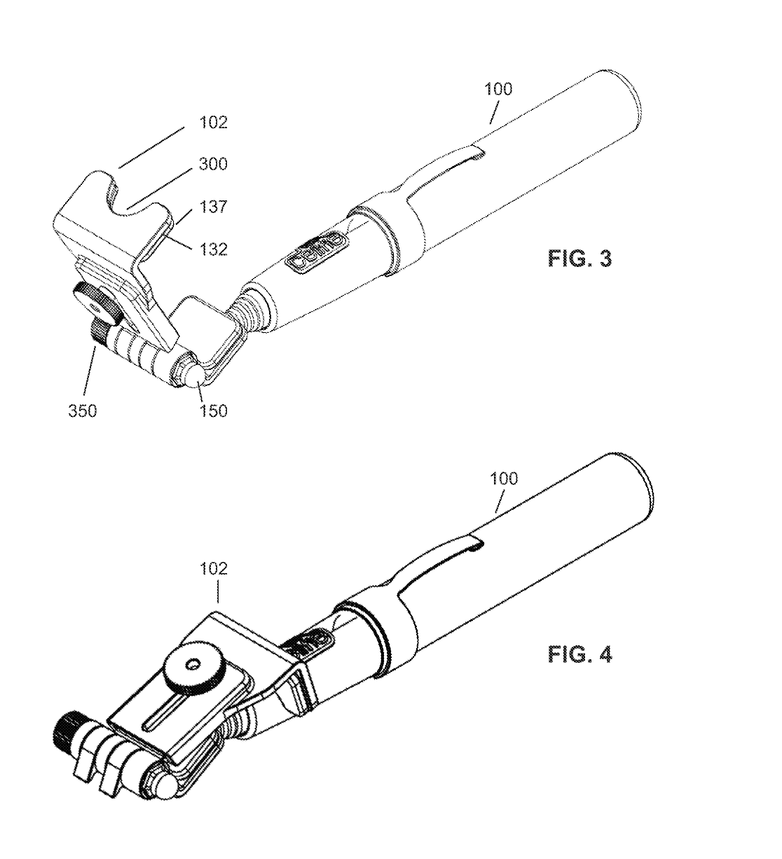

FIG. 3 shows a perspective view of the portable electronic device holder in the active position. The second clamping surface 132 includes a notch 300 for further engaging the handle in the idle position. Furthermore, friction pad 137 includes a corresponding notch to facilitate the engaging of the handle in the idle position. The notch in the second camping surface and the second friction pad does not significantly reduce the ability of the second clamping surface to clamp side 128 of the portable electronic device, while enabling further engagement with the handle and thus further reduction of the clamp in the idle position. The contoured geometry allows the clamp section to intimately fit or interlock with handle when folded.

FIG. 3 also shows that hinge 150 includes a second locking lug 350 for locking the hinge in at least one of the active position and the idle position. When the second locking lug 350 is rotated clockwise and tightened, the hinge 150 is locked in its current position. When the second locking lug 350 is rotated counterclockwise and loosened, the hinge 150 is unlocked and able to pivot between the active and idle positions. In other examples, other assemblies for locking and unlocking the clamp in the idle and active positions are considered to be within the scope of this description.

FIG. 4 shows a perspective view of the portable electronic device holder in the idle position. In the idle position the notch 300 receives the handle 100, thereby enhancing the reducing of the size of the clamp 102 in the idle position while enabling the clamping of the portable electronic device in the active position. Further note that the sliding arm assembly has a sliding range that facilitates the clamping of portable electronic devices of various dimensions. The second clamping surface includes a notch for receiving the handle in the idle position thereby enhancing the reducing of the size of the clamp in the idle position. The configuration further allows for the enhance reduction of the size of the clamp throughout the sliding range of the sliding arm assembly while enabling the clamping of the portable electronic devices of various dimensions in the active position. Thus, sliding arm assembly may be set and/or locked anywhere within it sliding range while realizing the enhanced reduction in size of the clamp. Furthermore, once the sliding arm assembly is adjusted for dimensions of a portable electronic device, it need not necessarily be readjusted even though the clamp 102 may be rotated between idle position and the active position. This allows for quick installation of the portable electronic device while allowing for quick and convenient rotation between the active position and the reduced size idle position, while allowing the sliding arm assembly to remain fixed in its sliding range by the first locking lug.

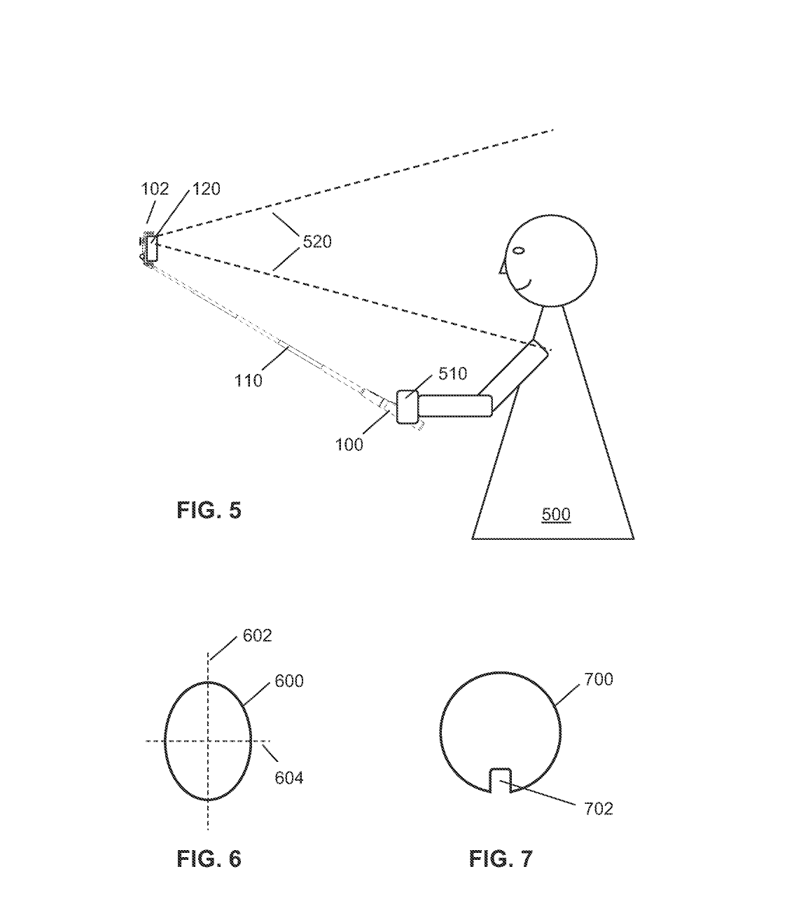

FIG. 5 shows a side view of a user recording a selfie image while holding the portable electronic device holder clamping a portable electronic device. User 500 has a hand 510 gripping the elliptical handle 100. Telescoping section 110 is shown extended. Clamp section 102 is shown clamping portable electronic device 120. The viewing range 520 of the camera of the portable electronic device is increased relative to the user due to the portable electronic device holder increasing the distance between the camera and the user beyond the arm's length distance achievable without the portable electronic device holder. This allows for more subject matter to be included in the selfie photograph. Thus, the user may monitor the front mounted display of the portable electronic device for adjusting the changing the distance and orientation of the camera relative to the user to obtained a desired selfie image. Note that the substantially thirty degree fixed angle of the first and second clamping surface of the clamp section provide for an easily usable positioning of the camera viewing range for recording selfie images. This angle advantageously eliminates the rotary hinge associated with monopods, thereby allowing a quick setup of the portable electronic device holder for recording selfie images as well as a reduced size when not clamping a portable electronic device.

In other examples, larger clamp sections may be used for larger devices. For example the clamp section shown in the figures may accommodate pocket sized portable devices such as cell phones, smart phones or pocket cameras. For tablets or phablets or other larger or differently sized portable electronic device a larger clamp section may be realized while remaining within the scope of this description. In one example a larger (or differently sized) clamp section 102 may be attached to screw 104. This allows for reuse of handle 100. In another example, second lock lug 350 for securing hinge 150 may be removed and a larger (or differently sized) sliding arm assembly 140 attached and secured with the hinge locking lug 350. This allows for reuse of handle 100 elements including lower clamping member 135, hinge 150 and second locking lug 350. In another example first locking lug 144 for sliding arm assembly 140 may be removed and (a larger or differently sized) clamping surface member 132 attached and secured with the first locking lug 144. This allows for reuse of handle 100 elements including lower clamping member 135, hinge 150 and second locking lug 350, as well as a portion of sliding arm assembly including first locking lug 144. Reuse of portions of the elements of the portable electronic device holder in accommodating various sizes of portable electronic devices not only adds to the convenience of the use of the device, but also reduces the cost and weight of the device with its various resized elements. In another example, the reuse of elements may reduce the cost of accessories used to facilitate differently sized portable electronic devices. In another example, the reuse or interchangeability of elements may be used for marketing purposes.

In other examples, the camera shutter of the portable electronic device may be remotely controlled using any number of approaches while remaining within the scope of this description. Such remote controls include audio signals received by the portable electronic device such as annunciating a word such as “cheese” or “smile”, visual signals such as a hand gesture received by the portable electronic device, or wireless control signals such as those generated by an infrared or Bluetooth wireless remote controller. In another example, the wireless remote controller including any corresponding control buttons and/or battery power supply may be incorporated into the handle 100 while remaining within the scope of this description.

The principles of the description have been described with reference to the described examples. Modifications and variations could occur to those upon reading and understanding the preceding detailed description. It is intended that the scope of the claims be construed as including all such modifications and alterations insofar as they come within the scope of the appended claims or equivalents thereof.

The description of the present application has been presented for purposes of illustration and description, but is not intended to be exhaustive or limited to the description in the form disclosed. Many modifications and variations will be apparent without departing from the scope of the description. The examples were chosen and described in order to best explain the principles of the description and the practical application, and to enable the understanding of the description for various examples with various modifications as are suited to the particular use.

What is claimed is:

1. A portable electronic device holder comprising:
a handle; and
a clamp attached to an end of the handle, the clamp including:
a first clamping surface coupled to the handle;
a second camping surface; and
a hinge coupled to the first clamping surface and the second clamping surface and for rotating the second clamping surface between
an active position for clamping a portable electronic device between the first clamping surface and the second clamping surface, and
an idle position for reducing a size of the clamp when not clamping the portable electronic device, wherein the second clamping surface rotates proximate to the handle in the idle position.

2. The portable electronic device holder according to claim 1 wherein the second clamping surface includes a notch for receiving the handle in the idle position, thereby enhancing the reducing of the size of the clamp in the idle position while enabling the clamping of the portable electronic device in the active position.

3. The portable electronic device holder according to claim 2 wherein the first clamping surface in is substantially covered by a first friction pad and the second clamping surface is substantially covered by a second friction pad, wherein second friction pad includes a second notch corresponding to the notch of the second clamping surface.

4. The portable electronic device according to claim 1 wherein the clamp further includes a sliding arm assembly having a sliding range, the sliding arm assembly coupled between the hinge and the second clamping surface for adjusting a distance between the first clamping surface and the second clamping surface in the active position to provide for clamping of a plurality of portable electronic devices of various dimensions.

5. The portable electronic device holder according to claim 4 wherein the second clamping surface includes a notch for receiving the handle in the idle position thereby enhancing the reducing of the size of the clamp in the idle position throughout the sliding range while enabling the clamping of the portable electronic device in the active position.

6. The portable electronic device holder according to claim 5 wherein the sliding arm assembly further includes a first locking lug for fixing a distance between the first clamping surface and the second clamping surface in the active position and the hinge further includes a second locking lug for locking the hinge in at least one of the active position and the idle position.

7. The portable electronic device holder according to claim 5 wherein in the active position
the hinge and the sliding arm assembly form a planar surface for receiving a corresponding planar surface of the portable electronic device,
the second clamping surface is perpendicular to the planar surface, and
the first clamping surface is parallel to the second clamping surface and at a fixed angle relative to the handle, the fixed angle being between twenty degrees and forty degrees.

8. The portable electronic device holder according to claim 7 wherein the fixed angle is substantially thirty degrees.

9. The device holder according to claim 1 wherein the portable electronic device clamped in the active position is one of a cell phone, a smart phone, a gaming system, a tablet and a phablet including a display and a camera orientated towards the handle.

10. The portable electronic device holder according to claim 9 wherein the first clamping surface has a substantially thirty degree angle relative to the handle, thereby orientating the portable electronic device substantially thirty degrees relative to the handle in the active position and allowing a user holding the handle to view and record a selfie image including the user while holding the portable electronic device holder.

11. The portable electronic device holder according to claim 1 wherein the handle is a telescoping handle.

12. The portable electronic device holder according to claim 11 wherein the telescoping handle has a shape of an ellipse having a long axis and a short axis wherein the long axis of the ellipse is perpendicular to the first clamping surface.

13. The portable electronic device holder according to claim 11 wherein the handle has a groove for deterring rotation of the portable electronic device relative to the handle.

14. The portable electronic device holder according to claim 1 wherein the clamp is detachably removable from the handle.

15. A portable electronic device holder comprising:
a handle; and
a clamp attached to an end of the handle, the clamp including
a first clamping surface having a fixed angle relative to the handle, the fixed angle being between twenty degrees and forty degrees; and
a second clamping surface parallel to the first clamping surface, wherein the first clamping surface and the second clamping surface are adapted to clamp side surfaces of a portable electronic device having a front surface mounted display and a front surface mounted camera whereby a user holding the handle may record a selfie image including the user with the portable electronic device.

16. The portable electronic device according to claim 15 further comprising a sliding arm assembly having a sliding range, the sliding arm assembly coupled between the first clamping surface and the second clamping surface for adjusting a distance between the first clamping surface and the second clamping surface to provide for clamping of a plurality of portable electronic devices of various dimensions, the sliding arm assembly presenting a planar surface for receiving a rear planar surface of the portable electronic device while clamped.

17. The portable electronic device according to claim 16 further comprising
a hinge coupled between the first clamping surface and the sliding arm assembly and for rotating the sliding arm assembly and the second clamping surface between
an active position for clamping the portable electronic device between the first clamping surface and the second clamping surface, and
an idle position for reducing a size of the clamp when not clamping the portable electronic device, wherein the second clamping surface rotates proximate to the handle in the idle position, wherein in the active position the hinge and the sliding arm assembly present the planar surface for receiving the rear planar surface of the portable electronic device while clamped.

18. The portable electronic device holder according to claim 17 wherein the second clamping surface includes a notch for receiving the handle in the idle position, thereby enhancing the reducing of the size of the clamp in the idle position while enabling the clamping of the portable electronic device in the active position.

19. The portable electronic device holder according to claim 18 wherein the first clamping surface in is substantially covered by a first friction pad and the second clamping surface is substantially covered by a second friction pad, wherein second friction pad includes a second notch corresponding to the notch of the second clamping surface.

20. A portable electronic device holder comprising:
a telescoping handle; and
a clamp attached to an end of the handle, the clamp including
a first clamping surface having a fixed angle relative to the handle, the fixed angle being between twenty degrees and forty degrees;
a second camping surface;
a sliding arm assembly attached to the second clamping surface; and
a hinge attached to the first clamping surface and the sliding arm assembly and for rotating the sliding arm assembly and the second clamping surface between
an active position for clamping a portable electronic device between the first clamping surface and the second clamping surface, and
an idle position for reducing a size of the clamp when not clamping the portable electronic device, wherein the second clamping surface rotates proximate to the handle in the idle position,
the second clamping surface includes a notch for receiving the handle in the idle position, thereby enhancing the reducing of the size of the clamp in the idle position while enabling the clamping of the portable electronic device in the active position,
in the active position, the hinge and the sliding arm assembly form a planar surface for receiving a corresponding planar surface of the portable electronic device and the second clamping surface is perpendicular to the planar surface and the first clamping surface is parallel to the second clamping surface,
the sliding arm assembly having a sliding range for adjusting a distance between the first clamping surface and the second clamping surface in the active position to provide for clamping of a plurality of portable electronic devices of various dimensions,
the first clamping surface and the second clamping surface adapted to clamp side surfaces of the portable electronic device, whereby the portable electronic device has a front surface mounted display and a front surface mounted camera and a user holding the handle may record a selfie-photograph of an image including the user, and the telescoping handle has an elliptical shape.
